(19) United States
(12) Patent Application Publication
(10) Pub. No.: US 2010/0137756 A1
(43) Pub. Date: Jun. 3, 2010

(54) DEVICE AND METHOD FOR EXERCISING THE LIPS AND FACIAL MUSCLES

(76) Inventor: Lara Van Der Velden, Kaiserslauten (DE)

Correspondence Address: Horst M Kasper, 12 Forest Drive, Warren, NJ, 07059, US

(21) Appl. No.: 12/312,137

(22) PCT Filed: Oct. 26, 2007
(86) PCT No.: PCT/DE2007/001932

§ 371 Date: Jan. 27, 2010

(30) Foreign Application Priority Data
Oct. 26, 2006 (DE) 20 2006 016 567.3

(51) Int. Cl. A61H 1/02

(52) U.S. Cl. 601/23

(57) ABSTRACT

The present invention proposes a method and a device (1) which, on the one hand allow the lips of the human mouth to be exercised and on the other hand prevent a formation of wrinkles in the mouth area. The device (1) according to the invention is placed on the teeth (4) of the upper and/or lower jaw and executes a relative movement between lips and U-shaped device (1).

The invention concerns a device for training of the lips and the facial muscles.

Such a device is known from the U.S. Pat. No. 3,774,485 A. The device described there comprises a handle with the U-shaped mouthpiece attached to the handle, wherein the mouthpiece can be brought into the intermediate space between the teeth and the inner side of the lips. After the insertion of the mouthpiece into the mouth chamber, the handle is moved alternatingly from the face away and toward the face. A stretching of the lips and face regions results therefrom.

Furthermore a training apparatus for facial muscles is known from the U.S. Pat. No. 3,805,771 A which comprises the disk, wherein the disk is inserted between the lips and the teeth and wherein the disk is connected with a rod. The disk is pulled against the lips through the rod, which is to strengthen the lip and face muscles.

The two previously recited devices are difficult to use in so far as the handle or, respectively, the rod protrudes out of the mouth during use and are therefore not suitable for use in public.

A stimulation apparatus is known from the U.S. Pat. No. 6,676,616 B1, wherein the stimulation apparatus is placed between the teeth and the lips and wherein the stimulation apparatus serves for stimulation of certain points. The stimulation apparatus can be formed from edible food, for example it can be chewing gum.

It is further known to employ substances such as botulinal toxin (for example Botox(R) of the company Allergan) for wrinkle therapy. This is however highly questionable, since this is a strong neuro toxin and is essentially registered for the medical treatment of certain spasms and for wrinkle therapy exclusively for the glabella wrinkle.

It may be necessary to train again the lip muscles after a disease, for example after a stroke, or to oppose an age related degradation of the lip muscles. In addition, also cosmetic aspects are to be considered, where for example more swollen lips are desired.

It is an object of the invention to furnish a device for training of lip and face muscles, wherein the device during its use is not or hardly at all observed and thus entails a good acceptance.

This object is resolved according to the present invention by furnishing a U-shaped mouthpiece, wherein the U-shaped mouthpiece exhibits exhibits a swelling in its region disposed adjoining to the lips and wherein the mouthpiece exhibits a tooth receiver for the disengageable attachment of the mouthpiece to the teeth of the user.

The swelling serves for training of the lip muscles by performing a relative motion between the teeth of the user, and the lips, wherein the device is attached onto the teeth of the user. It has been shown that with a daily application (possibly also several times a day) of the invention device, the lip muscles are clearly strengthened within a very short time.

It is advantageous that the swelling contains agents for stimulating the lip muscles.

The stimulating effect can be increased by furnishing the swelling with a structure, wherein the swelling makes contact with the inner side of the lips.

It can be provided in this context that the agents for stimulating the lip muscles are formed as projections and/or recesses.

These projections or, respectively, recesses increase the massaging effect and therewith the degree of stimulation.

Furthermore it is advantageous where the mouthpiece is transparent.

The mouthpiece makes thereby less of an impression during its use.

An embodiment of the invention comprises that the tooth receiver is furnished of elastic material.

It is thereby possible to produce the device in larger series, which device can be used without an individual adaptation.

It is advantageous in this context that the tooth receiver comprises two swellings for resting at the outer side of the teeth and at the inner side of the teeth.

The variations, which are present by nature from denture to denture, can be balanced thereby.

Another embodiment of the invention comprises that the tooth receiver is adapted to the individual tooth picture of the user.

It is also possible to produce an impression of the teeth and based on this impression to adapt the tooth receiver to the individual tooth picture based on this impression, such that the tooth receiver can be attached shape matchingly on the teeth of the lower jaw and the upper jaw.

In the following the invention is described in more detail by way of an embodiment example.

There is shown in:

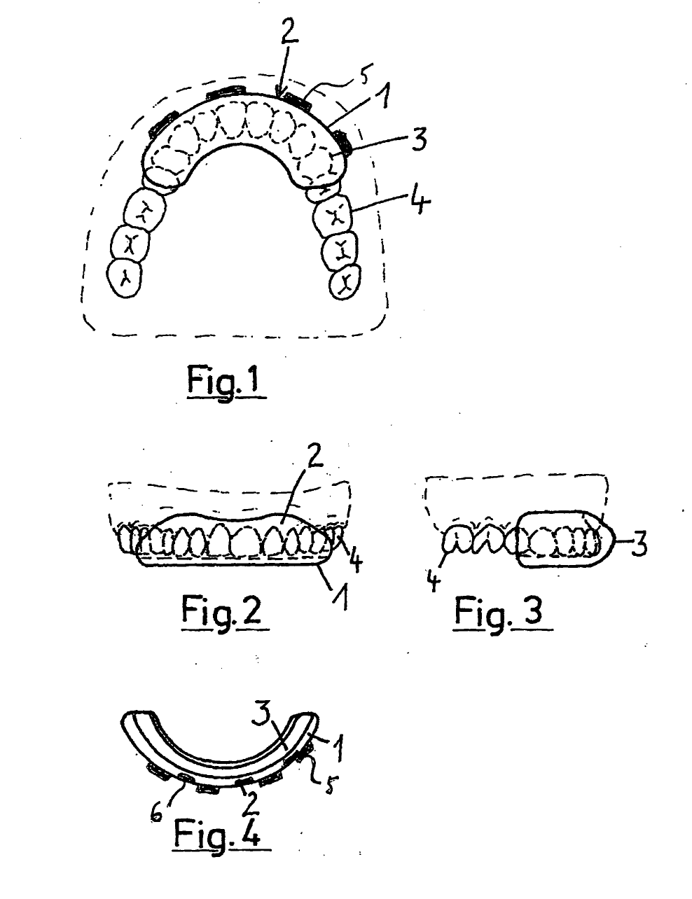

FIG. 1 a top planar view onto a jaw with an invention device,

FIG. 2 a front elevational view of the jaw with the invention device,

FIG. 3 a side elevational view of the jaw with the invention device,

FIG. 4 a top planar view onto an invention device.

As can be recognized from FIGS. 1 through 4, there is furnished a U-shaped mouthpiece 1 according to the present invention, wherein the mouthpiece 1 is furnished with a swelling 2 (compare FIG. 3) and exhibits your (translator's remark: should be “a”) tooth receiver 3 for attaching to the teeth 4 of the user.

The swelling serves for stimulating the lip and facial muscles and can be furnished with agents (not shown here) for stimulating the lip muscles, for example with projections and/or devices (translator's remark: should be “recesses”). The stimulating effect, which already exists by the pressing on or, respectively, rubbing of the swelling 2 against the lip muscles, can be further increased through this structuring of the swelling 2.

The mouthpiece 1 ‘in front of’ (translator's remark: should be “is”) preferably produced out of a transparent material, for example out of transparent plastic, such that the mouthpiece 1 is little noticeable also when the mouth is open.

The tooth receiver 3 extends, as illustrated, up to about the buccal teeth, however it can be formed both shorter as well as also longer. The tooth receiver 3 can be produced out of elastic material and can for example exhibit two swellings (not illustrated) for resting at the outer side of the teeth and at the inner side of the teeth. Such a tooth receiver 3 can be produced for a multitude of users in screen production (translators remark: should be series production) and adapts well to the respective tooth picture.

It is also possible alternatively that the tooth receiver 3 is adapted to the individual tooth picture of the user. Then the tooth receiver 3 can be formed out of a harder material, since in this case a shape matching holding of the tooth receiver 3 at the teeth 4 of the user is given.

1. Device for the training of lip muscles, wherein a U-shaped mouthpiece (1) is furnished, wherein the U-shaped mouthpiece (1) in its region adjoining the lips exhibits a swelling (2) and wherein the mouthpiece (1) exhibits a tooth receiver (3) for the disengageable attachment of the mouthpiece (1) to the teeth (4) of the user.

2. Device according to claim 1, wherein the swelling (2) exhibits agents for stimulating the lip muscles.

3. Device according to claim 2, wherein the agents for stimulating the lip muscles are formed as projections and/or recesses.

4. Device according to claim 1, wherein the mouthpiece (1) is transparent.

5. Device according to claim 1, wherein the tooth receiver (3) comprises an elastic material.

6. Device according to claim 5, wherein the tooth receiver (3) exhibits two swellings for resting at the outer side of the teeth and at the inner side of the teeth.

7. Device according to claim 1, wherein the tooth receiver (3) is adapted to the individual tooth picture of the user.

8. Device according to claim 1, wherein the projections (5) and the recesses (6) are formed elongated and bent.

9. Device according to claim 1, wherein the projections (5) and the recesses (6) are formed with point shape.

10. Device according to one of the preceding claims, wherein the projections (5) are produced in two component technology.

11. Device according to one of the preceding claims, wherein the projections (5) are relative to the U-shaped mouthpiece (1) and/or softer as the remaining material.

12. Device according to one of the preceding claims, whereinthe material is an elastomer or silicone or a mixture of both.

13. Device according to claim 1, wherein the motion of the mouthpiece (1) is effected by way of a drive.

14. Use of a training device for the upper and lower lips of the human mouth, wherein the device (1) produced according to claim 1 is superpositioned onto the upper lip or the lower lip or onto both at the same time.

15. Method for training the lower lip and the upper lip of the human mouth, wherein a U-shaped device (1) out of a food edible material is placed onto the teeth (4) of the upper and/or lower jaw of the human mouth and wherein a relative motion is exerted by moving the upper and/or lower lips.

16. Method according to claim 15, wherein the relative motion between lips and mouthpiece (1) is effected by way of a drive, wherein the drive is force matchingly coupled to the U-shaped formed mouthpiece (1).
